(19) United States
(12) Patent Application Publication
(10) Pub. No.: US 2016/0347634 A1
(43) Pub. Date: Dec. 1, 2016

(54) METHOD FOR THE CATALYZED REDUCTION OF HALOGEN OXYANIONS IN AQUEOUS SOLUTIONS

(71) Applicant: QID S.R.L., Vicenza (IT)

(72) Inventors: Renzo Rosei, Trieste (IT); Luca Conte, Pederobba (IT); Alessandro Trovarelli, Pagnacco (IT); Marta Boaro, Fossalta Di Portogruaro (IT); Stefano Gallucci, Padova (IT); Massimo Centazzo, Camisano Vicentino (IT); Rosanna Toniolo, Campoformido (IT)

(21) Appl. No.: 15/116,636

(22) PCT Filed: Feb. 18, 2015
(86) PCT No.: PCT/EP2015/005336

§ 371 Date: Aug. 4, 2016

(30) Foreign Application Priority Data
Feb. 18, 2014 (IT) PD2014A000033

(51) Int. Cl. C02F 1/70; B01J 23/656

(52) U.S. Cl. CPC C02F 1/705; B01J 23/6567; C02F 2101/12

(57) ABSTRACT

A method for removing halogen oxyanions, in particular chlorine and bromine, by hydrogenation reduction catalysed with supported catalysts based on rhenium and noble metals of subgroup VIII of the Periodic Table of the Elements is herein disclosed. The combination of the noble metals with rhenium has proved to considerably increase the catalytic efficiency of such metals.

### CROSS REFERENCE TO RELATED APPLICATIONS

The present application claims priority to PCT International Application No. PCT/EP2015/053366 filed on Feb. 18, 2015, which application claims priority to Italian Patent Application No. PD2014A000033 filed Feb. 18, 2014, the entirety of the disclosures of which are expressly incorporated herein by reference.

### STATEMENT RE: FEDERALLY SPONSORED RESEARCH/DEVELOPMENT

Not Applicable.

### FIELD OF THE INVENTION

The invention relates to a method for the removal of halogen oxyanions, in particular chlorine and bromine, from aqueous solutions by catalyzed hydrogenation reduction in heterogeneous phase.

### BACKGROUND ART

The scope of the invention is that of water purification which usually involves processes based on one or more treatments different from each other to eliminate or at least reduce the organic substances and microorganisms within the limits prescribed. One of the most used methods, together with filtration, provides oxidative treatments with chlorine-based compounds, such as hypochlorites, and ozone. The oxidative treatment, however, produces by-products containing halogen oxyanions, such as bromates and perbromates, chlorates and perchlorates, which must in turn be removed.

U.S. Pat. No. 5,779,915 discloses a method for the removal of chlorates and bromates by hydrogenation catalyzed with a catalyst based on noble metals of subgroup VIII of the Periodic Table of the Elements, platinum, palladium, iridium, rhodium, supported on inorganic oxides. In a preferred embodiment, the active metal of the catalyst is palladium in combination with elements of group 1b of the Periodic Table of the Elements such as copper or silver. The catalysts are prepared by impregnation with the selected metal or metals of the support material and the metal loading is between 0.1 and 10% by weight, preferably between 0.1 and 5% and more preferably between 0.2 and 2%. The catalysts with a Pd content between 0.1 and 2%, and in particular between 0.1 and 1%, were found to be the most advantageous, whereas when Pd is in combination with copper, the atomic ratios between the two elements Pd:Cu are between 1:1 and 8:1 and preferably between 1:1 and 4:1. Catalyzed hydrogenations of bromate and chlorate are described, wherein the supported catalyst is a catalyst based on Pd (content by weight: 1% and 0.89%) or Pd/Cu (content by weight: Pd 1%, Cu 0.25% and Pd 0.23%, Cu 0.28%).

U.S. Pat. No. 6,270,682 discloses a method for the removal of chlorates and bromates by catalyzed hydrogenation with a supported catalyst based on rhodium, platinum or palladium, wherein rhodium is the active metal with a higher catalytic activity than platinum and palladium (e.g. Rh>Pt>Pd), while keeping the content in % by weight of the same constant. Therefore, preferably the active metal is rhodium or platinum on a non-oxide support, such as SiC, graphite, activated carbon, or an oxide, such as ZrO₂, with a metal loading comprised from 0.01 to 5% by weight and preferably from 0.1 to 2% by weight.

In no case bimetallic catalysts are mentioned for the catalyst in which the noble metals of subgroup VIII of the Periodic Table of the Elements, platinum, palladium, iridium, rhodium, are combined with a metal of group VIIb of the Periodic Table of the Elements, such as rhenium, for the catalyzed removal of halogen oxyanions from aqueous solutions.

Bimetallic catalysts based on rhenium in combination with metals of group VIII of the Periodic Table of the Elements are known, for example, for oil refining (Sinfelt J H, Acc. Chem. Res., 1987, 20 134-139), for selective reduction of amides (Chitaru H et al., Tetrahedron Lett., 1996, 37, 6749-6752; Beamson G et al., J. Catalysis, 2011, 278, 228-238) or polyols and cyclic ethers (Chia M et al. J. Am. Chem. Soc., 2011, 133, 12675-12689).

### SUMMARY

The inventors have now found that the combination of noble metals of subgroup VIII of the Periodic Table of the Elements with rhenium causes a catalytic efficiency in the reduction by hydrogenation of chlorine oxyanions, which is much higher compared to the catalyst wherein the active metal is only a noble metal of subgroup VIII.

Therefore, in one aspect the object of the invention is a method for the removal of halogen oxyanions from aqueous solutions by hydrogenation reduction, wherein the hydrogenation reduction reaction is catalyzed by a supported bimetallic catalyst comprising rhenium in combination with a noble metal of subgroup VIII of the Periodic Table of the Elements. The oxyanion halogens can be bromine and chlorine, in particular the oxyanions can be bromates and perbromates, chlorates and perchlorates, preferably they are the chlorine oxyanions chlorates and perchlorates.

In another aspect a further object of the invention is a bimetallic supported catalyst comprising rhenium in combination with a noble metal of subgroup VIII of the Periodic Table of the Elements, in particular iridium, rhodium and platinum, for use in hydrogenation reduction reaction of halogen oxyanions, in particular bromine and chlorine.

### BRIEF DESCRIPTION OF THE FIGURES

FIG. 1. The figure shows the hydrogenation reduction of ClO₃⁻ ions with bimetallic iridium and rhenium catalysts of example 1 (Ir_{95%}, Re_{5%}), 3 (Ir_{85%}, Re_{15%}) and 4 (Ir_{75%}, Re_{25%}) compared with monometallic iridium and rhenium catalysts; the catalysts are supported on SiO₂ with a total metal loading of 0.4% by weight.

FIG. 2. The figure shows the hydrogenation reduction of ClO₄⁻ ions with bimetallic iridium and rhenium catalysts of example 1 (Ir_{95%}, Re_{5%}), 3 (Ir_{85%}, Re_{15%}) and 4 (Ir_{75%}, Re_{25%}) compared with monometallic iridium and rhenium catalysts; the catalysts are supported on SiO₂ with a total metal loading of 0.4% by weight.

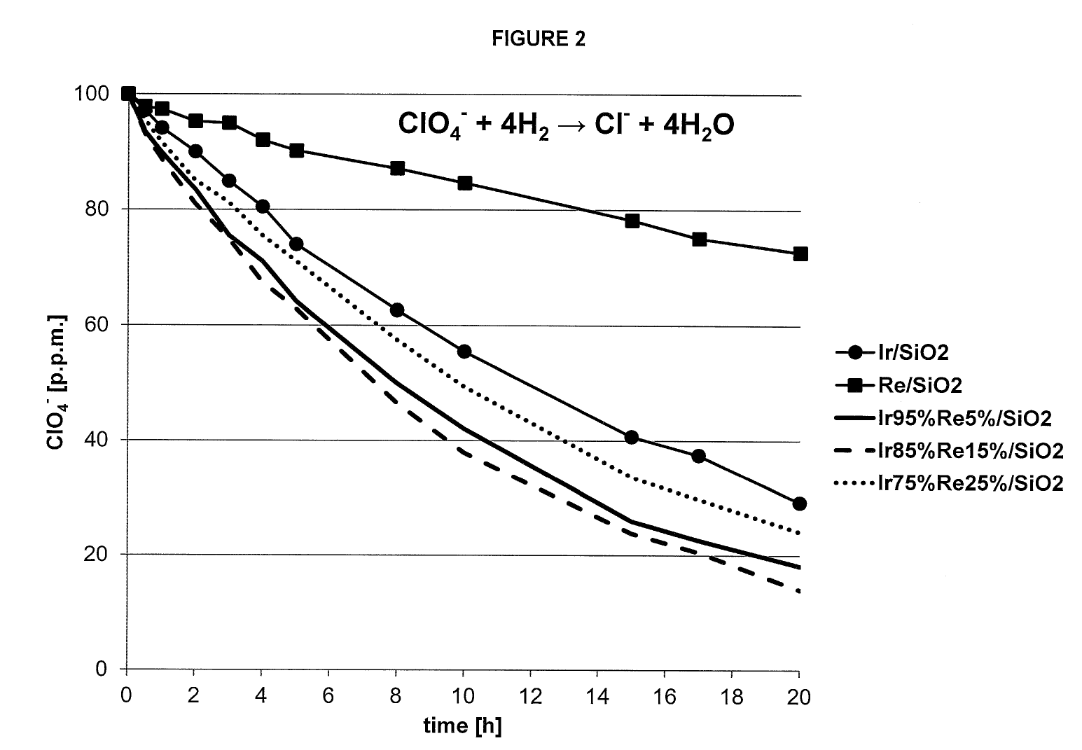

FIG. 3. The figure shows the hydrogenation reduction of ClO₃⁻ ions with bimetallic iridium and rhenium catalysts of example 5 (Ir_{95%}, Re_{5%}), 6 (Ir_{85%}, Re_{15%}) and 7 (Ir_{75%}, Re_{25%}) compared with monometallic iridium and rhenium catalysts; the catalysts are supported on C with a total metal loading of 0.4% by weight.

FIG. 4. The figure shows the hydrogenation reduction of ClO₄⁻ ions with bimetallic iridium and rhenium catalysts of example 5 (Ir_{95%}, Re_{5%}), 6 (Ir_{85%}, Re_{15%}) and 7 (Ir_{75%}, Re_{25%}) compared with monometallic iridium and rhenium catalysts; the catalysts are supported on C with a total metal loading of 0.4% by weight.

FIG. 5. The figure shows the hydrogenation reduction of ClO₃⁻ ions with bimetallic rhodium and rhenium catalysts of example 8 (Rh_{95%}, Re_{5%}), 9 (Rh_{85%}, Re_{15%}) and 10 (Rh_{75%}, Re_{25%}) compared with monometallic rhodium and rhenium catalysts; the catalysts are supported on SiO₂ with a total metal loading of 0.4% by weight.

FIG. 6. The figure shows the hydrogenation reduction of ClO₄⁻ ions with bimetallic rhodium and rhenium catalysts of example 8 (Rh_{95%}, Re_{5%}), 9 (Rh_{85%}, Re_{15%}) and 10 (Rh_{75%}, Re_{25%}) compared with monometallic rhodium and rhenium catalysts; the catalysts are supported on SiO₂ with a total metal loading of 0.4% by weight.

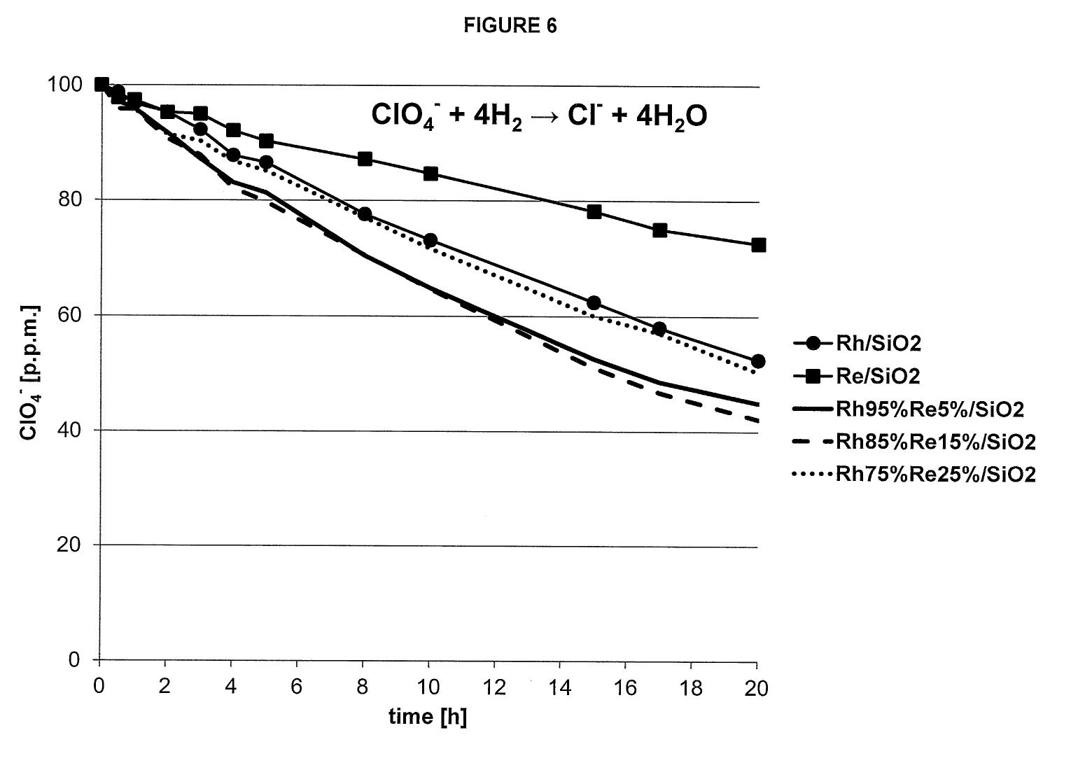

FIG. 7. The figure shows the hydrogenation reduction of ClO₃⁻ ions with bimetallic rhodium and rhenium catalysts of example 11 (Rh_{95%}, Re_{5%}), 12 (Rh_{85%}, Re_{15%}) and 13 (Rh_{75%}, Re_{25%}) compared with monometallic rhodium and rhenium catalysts; the catalysts are supported on C with a total metal loading of 0.4% by weight.

FIG. 8. The figure shows the hydrogenation reduction of ClO₄⁻ ions with bimetallic rhodium and rhenium catalysts of example 11 (Rh_{95%}, Re_{5%}), 12 (Rh_{85%}, Re_{15%}) and 13 (Rh_{75%}, Re_{25%}) compared with monometallic rhodium and rhenium catalysts; the catalysts are supported on C with a total metal loading of 0.4% by weight.

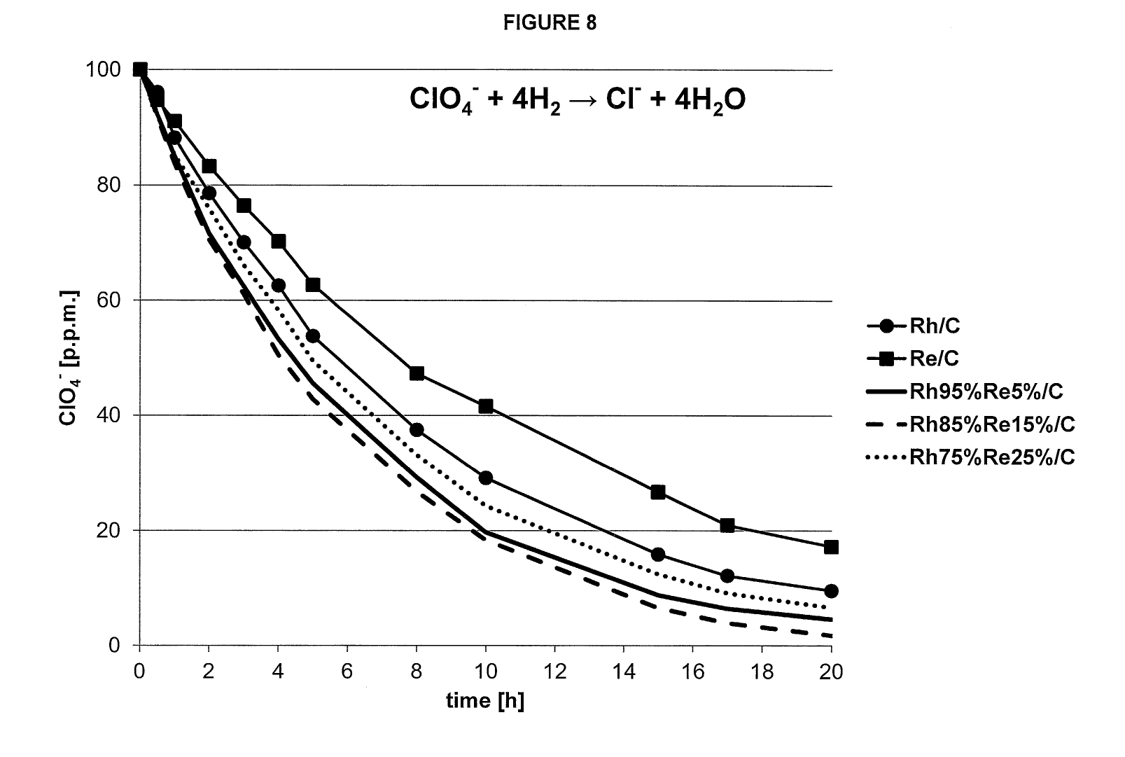

FIG. 9. The figure shows the hydrogenation reduction of ClO₃⁻ ions with bimetallic platinum and rhenium catalysts of example 14 (Pt_{85%}, Re_{15%}) and 15 (Pt_{75%}, Re_{25%}) compared with monometallic platinum and rhenium catalysts; the catalysts are supported on SiO2 with a total metal loading of 0.4% by weight.

FIG. 10. The figure shows the hydrogenation reduction of ClO₄⁻ ions with bimetallic platinum and rhenium catalysts of example 14 (Pt_{85%}, Re_{15%}), and 15 (Pt_{75%}, Re_{25%}) compared with monometallic platinum and rhenium catalysts; the catalysts are supported on SiO2 with a total metal loading of 0.4% by weight.

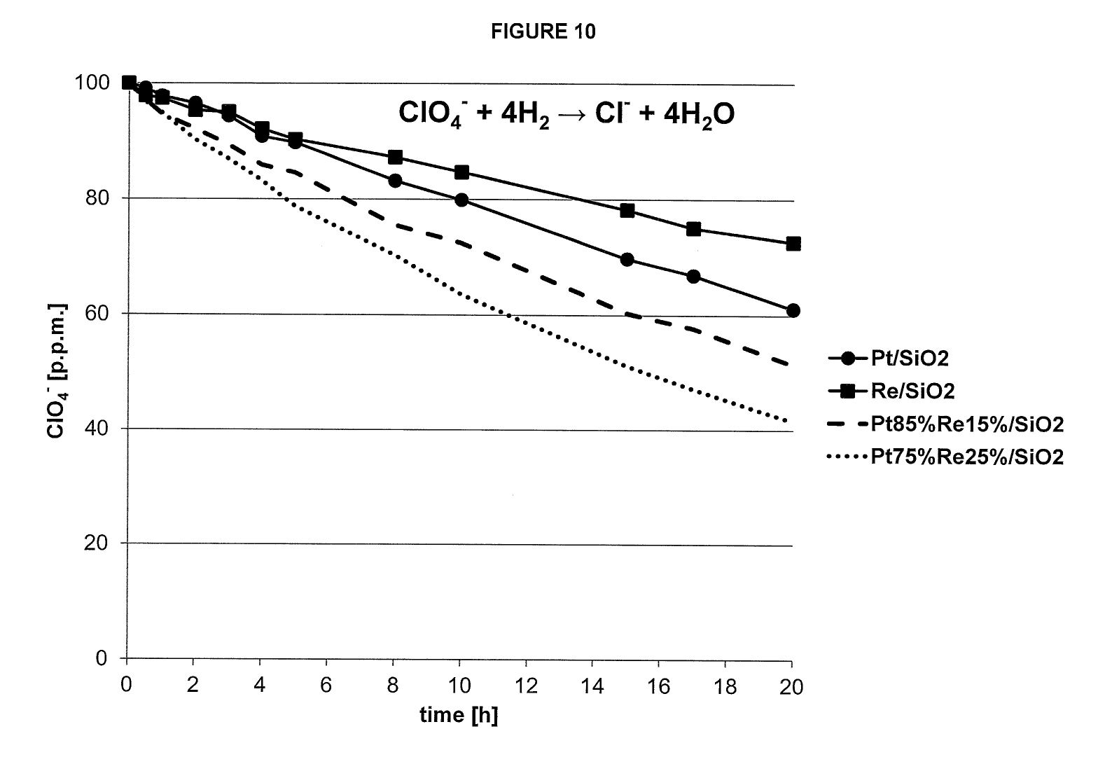

FIG. 11. The figure shows the hydrogenation reduction of ClO₃⁻ ions with bimetallic platinum and rhenium catalysts of example 16 (Pt_{85%}, Re_{15%}), and 17 (Pt_{75%}, Re_{25%}) compared with monometallic platinum and rhenium catalysts; the catalysts are supported on C with a total metal loading of 0.4% by weight.

FIG. 12. The figure shows the hydrogenation reduction of ClO₄⁻ ions with bimetallic platinum and rhenium catalysts of example 16 (Pt_{85%}, Re_{15%}) and 17 (Pt_{75%}, Re_{25%}) compared with monometallic platinum and rhenium catalysts; the catalysts are supported on C with a total metal loading of 0.4% by weight.

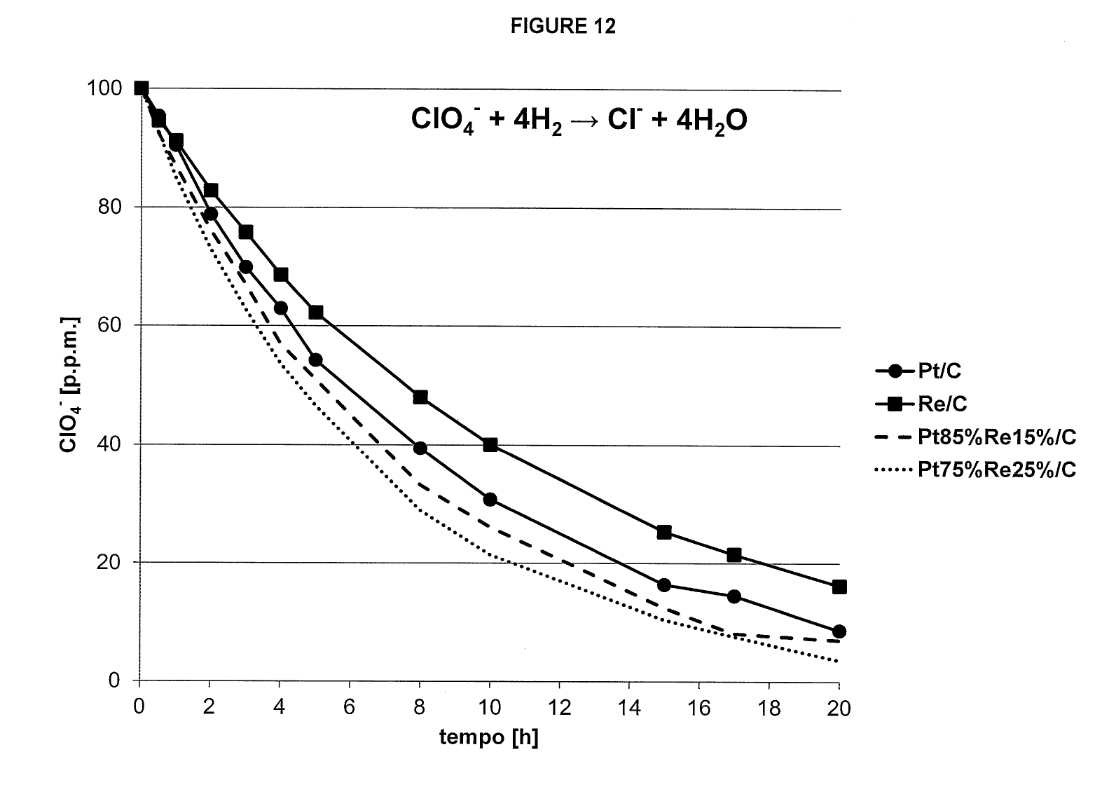

FIG. 13. The figure shows the hydrogenation reduction of ClO₃⁻ ions with bimetallic iridium and rhenium catalyst of example 18 (Ir_{85%}, Re_{15%}), compared with monometallic iridium and rhenium catalysts; the catalysts are supported on TiO₂ with a total metal loading of 0.4% by weight.

FIG. 14. The figure shows the hydrogenation reduction of ClO₄⁻ ions with bimetallic iridium and rhenium catalyst of example 18 (Ir_{85%}, Re_{15%}), compared with monometallic iridium and rhenium catalysts; the catalysts are supported on TiO₂ with a total metal loading of 0.4% by weight.

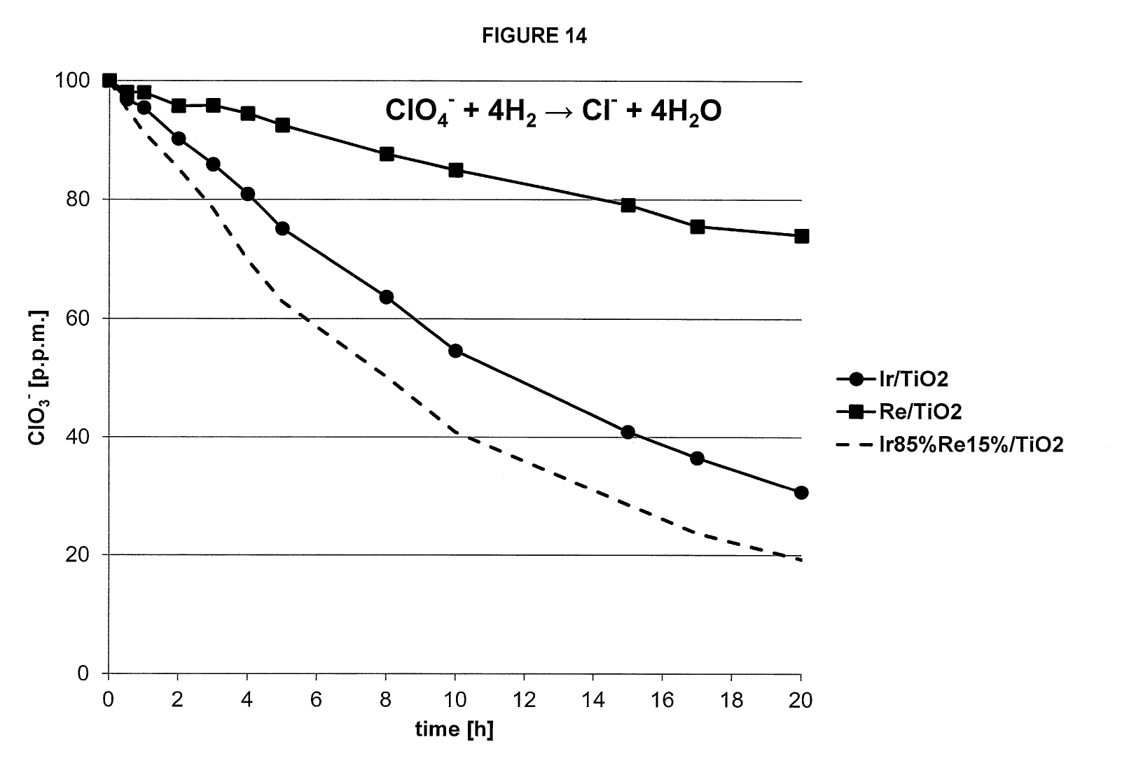

FIG. 15. The figure shows the hydrogenation reduction of ClO₃⁻ ions with bimetallic rhodium and rhenium catalyst of example 19 (Rh_{85%}, Re_{15%}), compared with monometallic rhodium and rhenium catalysts; the catalysts are supported on TiO₂ with a total metal loading of 0.4% by weight.

FIG. 16. The figure shows the hydrogenation reduction of ClO₄⁻ ions with bimetallic rhodium and rhenium catalyst of example 19 (Rh_{85%}, Re_{15%}), compared with monometallic rhodium and rhenium catalysts; the catalysts are supported on TiO₂ with a total metal loading of 0.4% by weight.

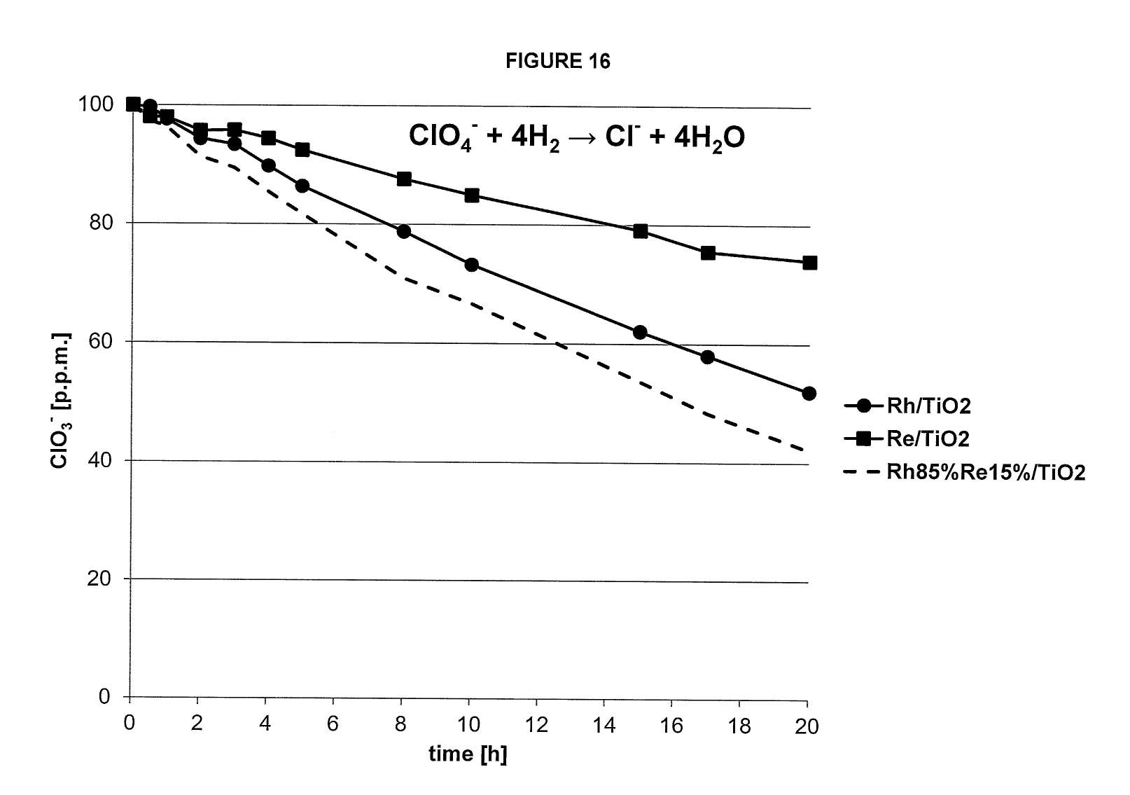

### DETAILED DESCRIPTION OF THE INVENTION

For the purposes of the present invention, the halogen oxyanions are anions of bromine and chlorine bromate, perbromate, chlorate and perchlorate and the method for removing the oxyanions of these halogens according to the invention uses a catalyzed hydrogenation reduction with formation of a halide anion and water. For example, for chlorate and perchlorate the catalyzed hydrogenation reactions are as follows:

ClO₃⁻+3H₂→Cl⁻+3H₂O

ClO₄⁻+4H₂→Cl⁻+4H₂O.

Similar reactions can be described for bromate and perbromate oxyanions.

Essentially, it is a hydrogenation in heterogeneous phase catalyzed by a supported catalyst, wherein the aqueous solution containing the oxyanions to be removed is treated with a flow of hydrogen H₂ under the conditions (preferably warm and at an acid pH) known by an artisan skilled in the art in presence of such supported catalyst.

In the case of the present invention, the catalyst is a supported bimetallic catalyst comprising rhenium in combination with noble metals of subgroup VIII of the Periodic Table of the Elements, which comprises metals such as cobalt, rhodium, iridium, nickel, palladium and platinum. For the purposes of the method according to the invention, these metals preferably are iridium, rhodium and platinum.

As will be clear from the detailed examples hereafter, it was verified that the supported bimetallic catalysts Ir/Re, Rh/Re and Pt/Re showed a significantly higher catalytic activity compared to the catalyst with only the metal Ir, Rh and Pt. The catalytic efficiency for the three different combinations Ir/Re, Rh/Re and Pt/Re is as follows: Ir/Re>Rh/Re>Pt/Re. Accordingly, the bimetallic catalyst Ir/Re is to be the most preferred catalyst for the method for removing from aqueous solutions oxyanions of the present invention.

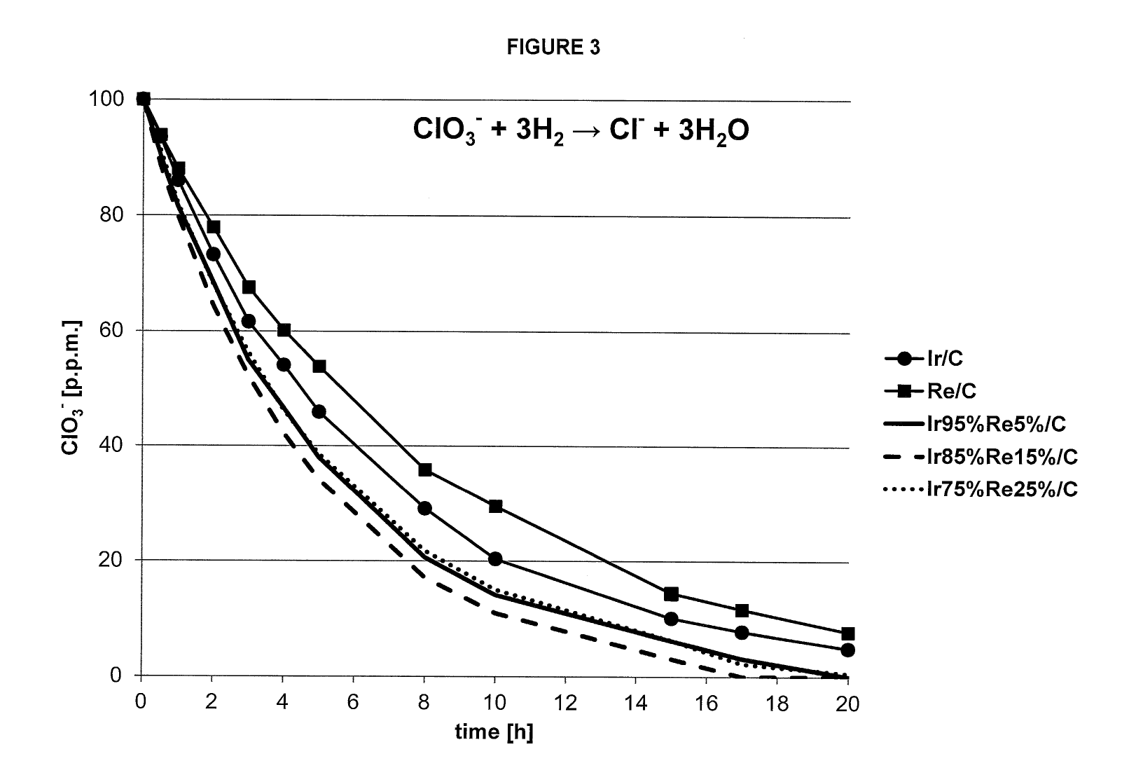

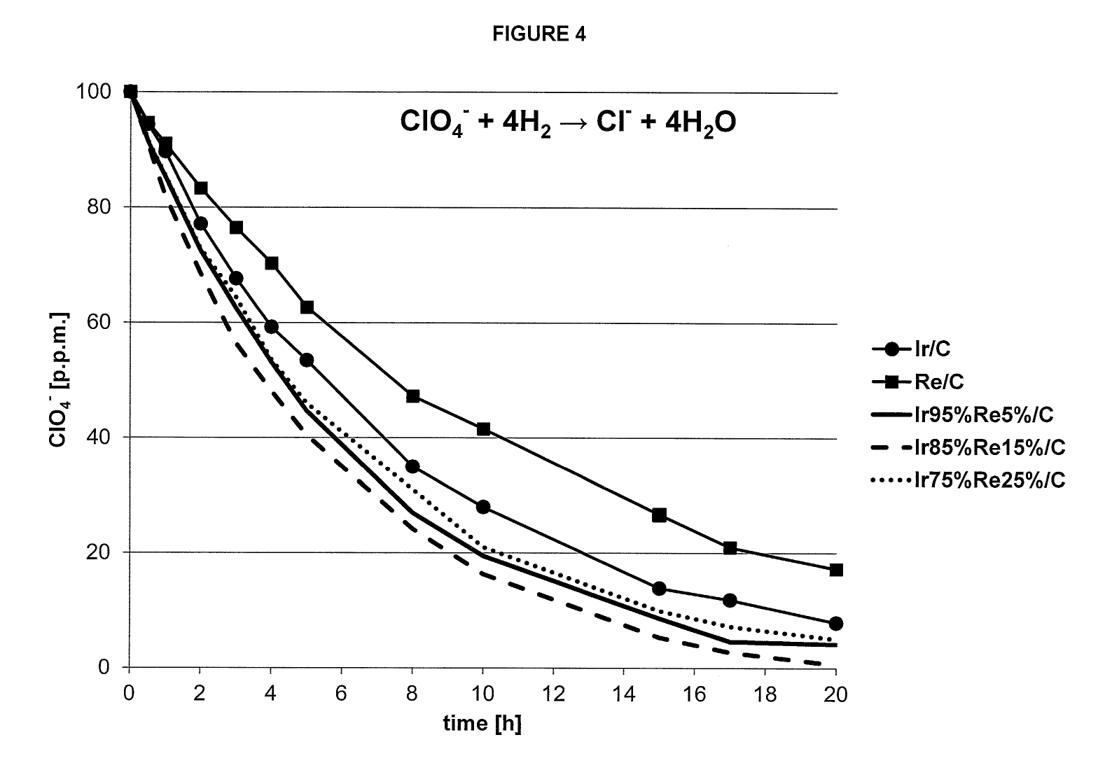

Remarkably, the addition of the active metal Rhenium always increases the catalytic activity of the compound, thus improving the performance of the catalyst regardless of the support on which the active metal compound is impregnated. As shown in FIGS. 3, 4, 7 and 11, this leads to the total reduction (i.e. below detectability limit of instrument) of the Cl oxoanions.

In these bimetallic catalysts, the total metal loading is in the range between 0.1 and 10% on the total catalyst weight and it preferably is between 0.1 and 1.0% by weight.

In relation to this metal loading, rhenium can be in the range between 1 and 50% by weight with respect to the total metal loading. Preferably, the rhenium loading is at least 5% by weight with respect to the total metal loading. If the metal is iridium or rhodium, the rhenium loading is more preferably in the range between 5 and 25% by weight with respect to the total metal loading, while if the metal is platinum, the rhenium loading is more preferably in the range between 15 and 35% by weight on the total metal weight. The most preferred rhenium metal loading is 15% with iridium or rhodium and 25% with platinum by weight respect to the total metal loading.

In one embodiment, the metals are supported on support materials consisting of metal oxides selected from silicon, aluminium, magnesium, titanium, cerium, zirconium and yttrium oxides and mixtures thereof. The preferred support material for the catalysts herein disclosed is SiO₂.

In another embodiment, the metals are supported on non-oxide support materials selected from carbon, and carbon and silicon SiC mixtures. The preferred support material in this group is carbon.

Both in the case of support material selected from metal oxides and from non-oxides, the technical features are: BET higher than 100 m²/gr, porosity higher than 0.05 cm³/gr and granulometry in the range between 1 and 10 mm.

The most preferred support material for all the different combinations Ir/Re, Rh/Re and Pt/Re is carbon, since the catalytic efficiency of metals supported on carbon has in all cases proved to be significantly higher than the same supported on SiO₂.

The catalysts used in the method for removing halogen oxyanions according to the invention are prepared according to known methods commonly applied for preparing these catalysts. In particular, catalysts Ir/Re, Rh/Re and Pt/Re herein disclosed were prepared by separate impregnation of the two metals with aqueous solutions of the metal precursors on the support material and with reductions of the metals with hydrogen subsequent to the two impregnations of the support with the metals.

The impregnation sequence of the two metals did not have a significant effect on the catalytic activity. Therefore, the impregnation can be carried out, for example, with Iridium first and then with Rhenium, or vice versa.

Therefore, the method for removing halogen oxyanions from aqueous solutions according to the invention comprises at least the step of:
reduction of the halogen oxyanions to halide by treating the aqueous solutions with a hydrogen flow in presence of a supported bimetallic catalysts comprising rhenium in combination with noble metals of subgroup VIII of the Periodic Table of the Elements.

The reduction is preferably carried out at temperatures comprised from 50° C. to 90° C. and pH from 2.0 to 3.0. The most preferred conditions are a temperature of 70° C. and pH equal to 2.5.

The examples of synthesis of catalysts Ir/Re, Rh/Re and Pt/Re and of catalyzed hydrogenations of chlorate and perchlorate anions with the same are hereafter reported for illustrative, non-limiting purposes of the invention.

### Examples

### Example 1

### Synthesis of the Catalyst Based on Iridium and Rhenium on a SiO₂ Support: Ir_{95%} Re_{5%} on SiO₂

The following reagents were used to prepare 10 gr catalyst:
10 g SiO₂ (BET=250 m²/g and porosity=1.0 cm³/g; granulometry=2-5 mm);
80 mg H₂IrCl₆;
2.9 mg NH₄ReO₄;
12 mL deionized water;
mixture of 5% H₂ in Ar (95%).

In a beaker, 80 mg of the Iridium precursor H₂IrCl₆ were dissolved in 8 mL deionized water under fast stirring for 15 min. in open air and at room temperature. In a second beaker, 2.9 mg of the Rhenium precursor NH₄ReO₄ were dissolved in 4 mL deionized water under fast stirring for 15 min., at room temperature and in air atmosphere.

The aqueous solution (8 mL) of the Ir precursor was added drop-wise to 10 g particles of SiO₂ under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was then dried for 2 hours in an oven at 100° C. in Ar atmosphere, and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained after reduction was subjected to mild oxidation with air at room temperature for 30 min. before exposure to the air.

10 g of an Ir/Re catalyst on a SiO₂ support were obtained; total metal loading equal to 0.4% on the total weight of the supported catalyst; Re loading equal to 5% on the total weight of the metal loading corresponding to an atomic ratio Ir:Re=18.43:1.

### Example 2

### Synthesis of the Catalyst Based on Iridium and Rhenium on a SiO₂ Support: Irg_{95%}Re_{5%} on SiO₂

The same synthesis of the catalyst in example 1 was repeated by first impregnating the silica support with the aqueous solution (4 mL) of the Re precursor and subjecting the sample to the same treatments up to reduction with H₂ diluted in Ar. The silica impregnated with Re was then treated with 8 mL aqueous solution of the Ir precursor and the sample was subjected to the same drying and reduction treatments up to the final mild oxidation as in example 1.

### Example 3

### Synthesis of the Catalyst Based on Iridium and Rhenium on a SiO₂ Support: Ir_{5%} Re_{15%} on SiO₂

The following reagents were used to prepare 10 gr catalyst:
10 g SiO₂ (BET=250 m²/g and porosity=1.0 cm³/g; granulometry=2-5 mm);
72 mg H₂IrCl₆;
8.7 mg NH₄ReO₄;
12 mL deionized water;
mixture of 5% H₂ in 95% Ar.

72 mg of the Iridium precursor H₂IrCl₆ were dissolved in 8 mL deionized water in a beaker under fast stirring for 15 minutes at room temperature and in open air. In another beaker, 8.7 mg of the Rhenium precursor NH₄ReO₄ were dissolved in 4 mL deionized water under fast stirring for 15 min., at room temperature and in air atmosphere.

The aqueous solution (8 mL) of the Ir precursor was added drop-wise to 10 g particles of SiO₂ under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was then dried for 2 hours in an oven at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Ir/Re catalyst on a SiO₂ support were obtained; total metal loading equal to 0.4% on the total weight of the supported catalyst; Re loading equal to 15% on the total weight of the metal loading corresponding to an atomic ratio Ir:Re=5.45:1.

### Example 4

### Synthesis of the Catalyst Based on Iridium and Rhenium on a SiO₂ Support: Ir_{75%} Re_{25%} on SiO₂

The following reagents were used to prepare 10 gr catalyst:
10 g SiO₂ (BET=250 m²/g and porosity=1.0 cm³/g; granulometry=2-5 mm);
63.5 mg H₂IrCl₆;
14.5 mg NH₄ReO₄;
12 mL deionized water;
mixture of 5% H₂ in 95% Ar.

In a beaker, 63.5 mg of the Iridium precursor H₂IrCl₆ were dissolved in 8 mL deionized water under fast stirring for 15 min. at room temperature and in air atmosphere. In another beaker, 14.5 mg of the Rhenium precursor NH₄ReO₄ were dissolved in 4 mL deionized water under fast stirring for 15 min., at room temperature and in air atmosphere.

The aqueous solution (8 mL) of the Ir precursor was added drop-wise to 10 g particles of SiO₂ under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was then dried for 2 hours in an oven at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Ir/Re catalyst on a SiO₂ support were obtained; total metal loading equal to 0.4% on the total weight of the supported catalyst; Re loading equal to 25% on the total weight of the metal loading corresponding to an atomic ratio Ir:Re=2.9:1.

### Example 5

### Synthesis of the Catalyst Based on Iridium and Rhenium on a Carbon Support: Ir_{95%} Re_{5%} on C

The following reagents were used to prepare 10 gr catalyst:
10 g C (BET=590 m²/g and porosity=1.4 cm³/g; granulometry=3-6 mm);
80 mg H₂IrCl₆;
2.9 mg NH₄ReO₄;
12 mL deionized water;
mixture of 5% H₂ in 95% Ar.

In a beaker, 80 mg of the Iridium precursor H₂IrCl₆ were dissolved in 8 mL deionized water under fast stirring for 15 min. in open air and at room temperature. In a second beaker, 2.9 mg of the Rhenium precursor NH₄ReO₄ were dissolved in 4 mL deionized water under fast stirring for 15 min. in open air and at room temperature.

The aqueous solution (8 mL) of the Ir precursor was added drop-wise to 10 g particles of carbon under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was then subjected to a second impregnation by drop-wise addition of the aqueous solution (4 mL) of the Re precursor. The sample was then dried for 2 hours in an oven at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Ir/Re catalyst on a C support were obtained; total metal loading equal to 0.4% on the total weight of the supported catalyst; Re loading equal to 5% on the total weight of the metal loading corresponding to an atomic ratio Ir:Re=18.43:1.

### Example 6

### Synthesis of the Catalyst Based on Iridium and Rhenium on a Carbon Support: Ir_{85%} Re_{15%} on C

The following reagents were used to prepare 10 gr catalyst:
10 g C (BET=590 m²/g and porosity=1.4 cm³/g; granulometry=3-6 mm);
72 mg H₂IrCl₆;
8.7 mg NH₄ReO₄;
12 mL deionized water;
mixture of 5% H₂ and Ar (95%).

In a beaker, 72 mg of the Iridium precursor H₂IrCl₆ were dissolved in 8 mL deionized water under fast stirring for 15 min. at room temperature and in air atmosphere. In another beaker, 8.7 mg of the Rhenium precursor NH₄ReO₄ were dissolved in 4 mL deionized water under fast stirring for 15 min. at room temperature and in air atmosphere.

The aqueous solution (8 mL) of the Ir precursor was added drop-wise to 10 g particles of carbon under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was then dried for 2 hours in an oven at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Ir/Re catalyst on a C support were obtained; total metal loading equal to 0.4% on the total weight of the supported catalyst; Re loading equal to 15% on the total weight of the metal loading corresponding to an atomic ratio Ir:Re=5.45:1.

### Example 7

### Synthesis of the Catalyst Based on Iridium and Rhenium on a Carbon Support: Ir_{75%} Re_{25%} on C

The following reagents were used to prepare 10 gr catalyst:
10 g C (BET=590 m²/g and porosity=1.4 cm³/g; granulometry=3-6 mm);
63.5 mg H₂IrCl₆;
14.5 mg NH₄ReO₄;
12 mL deionized water;
mixture of 5% H₂ in Ar (95%).

In a beaker, 63.5 mg of the Iridium precursor H₂IrCl₆ were dissolved in 8 mL deionized water under fast stirring for 15 min. at room temperature and in air atmosphere. In another beaker, 14.5 mg of the Rhenium precursor NH₄ReO₄ were dissolved in 4 mL deionized water under fast stirring for 15 min. at room temperature and in air atmosphere.

The aqueous solution (8 mL) of the Ir precursor was added drop-wise to 10 g particles of carbon under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was then dried for 2 hours in an oven at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Ir/Re catalyst on a C support were obtained; total metal loading equal to 0.4% on the total weight of the supported catalyst; Re loading equal to 25% on the total weight of the metal loading corresponding to an atomic ratio Ir:Re=2.9:1.

### Example 8

### Synthesis of the Catalyst Based on Rhodium and Rhenium on a SiO₂ Support: Rh_{95%} Re_{5%} on SiO₂

The following reagents were used to prepare 10 gr catalyst:
10 g SiO₂ (BET=250 m²/g and porosity=1.0 cm³/g; granulometry=2-5 mm);
106 mg Rh(NO₃)₃;
2.9 mg NH₄ReO₄;
12 mL deionized water;
mixture of 5% H₂ in Ar (95%).

In a beaker, 106 mg of the Rhodium precursor Rh(NO₃)₃ were dissolved in 8 mL deionized water under fast stirring for 15 min. at room temperature and in air atmosphere. In another beaker, 2.9 mg of the Rhenium precursor NH₄ReO₄ were dissolved in 4 mL deionized water under fast stirring for 15 min. at room temperature and in air atmosphere.

The aqueous solution (8 mL) of the Rh precursor was added drop-wise to 10 g particles of SiO₂ under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was dried for 2 hours in an oven at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Rh/Re catalyst on a SiO₂ support were obtained; total metal loading equal to 0.4% on the total weight of the supported catalyst; Re loading equal to 5% on the total weight of the metal loading corresponding to an atomic ratio Rh:Re=34:1.

### Example 9

### Synthesis of the Catalyst Based on Rhodium and Rhenium on a SiO₂ Support: Rh_{85%} Re_{15%} on SiO₂

The following reagents were used to prepare 10 gr catalyst:
10 g SiO₂ (BET=250 m²/g and porosity=1.0 cm³/g; granulometry=2-5 mm);
95 mg Rh(NO₃)₃;
8.7 mg NH₄ReO₄;
12 mL deionized water;
mixture of 5% H₂ in Ar (95%).

In a beaker, 95 mg of the Rhodium precursor Rh(NO₃)₃ were dissolved in 8 mL deionized water under fast stirring at room temperature and in air atmosphere. In another beaker, 8.7 mg of the Rhenium precursor NH₄ReO₄ were dissolved in 4 mL deionized water under fast stirring for 15 min. at room temperature and in air atmosphere.

The aqueous solution (8 mL) of the Rh precursor was added drop-wise to 10 g particles of SiO₂ under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was dried for 2 hours in an oven at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Rh/Re catalyst on a SiO₂ support were obtained; total metal loading equal to 0.4% on the total weight of the supported catalyst; Re loading equal to 15% on the total weight of the metal loading corresponding to an atomic ratio Rh:Re=10:1.

### Example 10

### Synthesis of the Catalyst Based on Rhodium and Rhenium on a SiO₂ Support: Rh_{75%} Re_{25%} on SiO₂

The following reagents were used to prepare 10 gr catalyst:
10 g SiO₂ (BET=250 m²/g and porosity=1.0 cm³/g; granulometry=2-5 mm);
84.5 mg Rh(NO₃)₃;
14.5 mg NH₄ReO₄;
12 mL deionized water;
mixture of 5% H₂ in Ar (95%).

In a beaker, 84.5 mg of the Rhodium precursor Rh(NO₃)₃ were dissolved in 8 mL deionized water under fast stirring for 15 min. at room temperature and in air atmosphere. In another beaker, 14.5 mg of the Rhenium precursor NH₄ReO₄ were dissolved in 4 mL deionized water under fast stirring for 15 min. at room temperature and in air atmosphere.

The aqueous solution (8 mL) of the Rh precursor was added drop-wise to 10 g particles of SiO₂ under stirring in a 100 mL beaker. The resulting sample was dried for 2 hours in an oven at 100° C. in Ar atmosphere and then left to cool down slowly in Ar atmosphere. The dried sample was subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was then dried for 2 hours in a stove at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Rh/Re catalyst on a SiO₂ support were obtained; total metal loading equal to 0.4% on the total weight of the supported catalyst; Re loading equal to 25% on the total weight of the metal loading corresponding to an atomic ratio Rh:Re=5.43:1.

### Example 11

### Synthesis of the Catalyst Based on Rhodium and Rhenium on a Carbon Support: Rh_{95%} Re_{5%} on C

The following reagents were used to prepare 10 gr catalyst:
10 g C (BET=590 m²/g and porosity=1.4 cm³/g; granulometry=3-6 mm);
106 mg Rh(NO₃)₃;
2.9 mg NH₄ReO₄;
12 mL deionized water;
mixture of 5% H₂ in Ar (95%).

In a beaker, 106 mg of the Rhodium precursor Rh(NO₃)₃ were dissolved in 8 mL deionized water under fast stirring at room temperature and in air. In another beaker, 2.9 mg of the Rhenium precursor NH₄ReO₄ were dissolved in 4 mL deionized water under fast stirring for 15 min. at room temperature and in air atmosphere.

The aqueous solution (8 mL) of the Rh precursor was added drop-wise to 10 g particles of carbon under stirring in a 100 mL beaker. The resulting sample was dried for 2 hours in an oven at 100° C. in Ar atmosphere and then left to cool down slowly in Ar atmosphere. The dried sample was subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was then dried for 2 hours in an oven at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Rh/Re catalyst on a C support were obtained; total metal loading equal to 0.4% on the total weight of the supported catalyst; Re loading equal to 5% on the total weight of the metal loading corresponding to an atomic ratio Rh:Re=34:1.

### Example 12

### Synthesis of the Catalyst Based on Rhodium and Rhenium on a Carbon Support: Rh_{85%} Re_{15%} on C

The following reagents were used to prepare 10 gr catalyst:
10 g C (BET=590 m²/g and porosity=1.4 cm³/g; granulometry=3-6 mm);
95 mg Rh(NO₃)₃;
8.7 mg NH₄ReO₄;
12 mL deionized water;
mixture of 5% H₂ in Ar (95%).

In a beaker, 95 mg of the Rhodium precursor Rh(NO₃)₃ were dissolved in 8 mL deionized water under fast stirring for 15 min. at room temperature and in air atmosphere. In another beaker, 8.7 mg of the Rhenium precursor NH₄ReO₄ were dissolved in 4 mL deionized water under fast stirring for 15 min. at room temperature and in air atmosphere.

The aqueous solution (8 mL) of the Rh precursor was added drop-wise to 10 g particles of carbon under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was dried for 2 hours in an oven at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Rh/Re catalyst on a C support were obtained; total metal loading equal to 0.4% on the total weight of the supported catalyst; Re loading equal to 15% on the total weight of the metal loading corresponding to an atomic ratio Rh:Re=10:1.

### Example 13

### Synthesis of the Catalyst Based on Rhodium and Rhenium on a Carbon Support: Rh_{75%} Re_{25%} on C

The following reagents were used to prepare 10 gr catalyst:
10 g C (BET=590 m²/g and porosity=1.4 cm³/g; granulometry=3-6 mm);
84.5 mg Rh(NO₃)₃;
14.5 mg NH₄ReO₄;
12 mL deionized water;
mixture of 5% H₂ in Ar (95%).

In a beaker, 84.5 mg of the Rhodium precursor Rh(NO₃)₃ were dissolved in 8 mL deionized water under fast stirring for 15 min. at room temperature and in air atmosphere. In another beaker, 14.5 mg of the Rhenium precursor NH₄ReO₄ were dissolved in 4 mL deionized water under fast stirring for 15 min. at room temperature and in air atmosphere.

The aqueous solution (8 mL) of the Rh precursor was added drop-wise to 10 g particles of carbon under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was then dried for 2 hours in an oven at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Rh/Re catalyst on a C support were obtained; total metal loading equal to 0.4% on the total weight of the supported catalyst; Re loading equal to 25% on the total weight of the metal loading corresponding to an atomic ratio Rh:Re=5.43:1.

### Example 14

### Synthesis of the Catalyst Based on Platinum and Rhenium on a SiO₂ Support: Pt_{85%} Re_{15%} on SiO₂

The following reagents were used to prepare 10 gr catalyst:
10 g SiO₂ (BET=250 m²/g and porosity=1.0 cm³/g; granulometry=2-5 mm);
71.45 mg H₂PtCl₆;
8.7 mg NH₄ReO₄;
12 mL deionized water;
mixture of 5% H₂ in Ar (95%).

In a beaker, 71.45 mg of the Platinum precursor H₂PtCl₆ were dissolved in 8 mL deionized water under fast stirring for 15 min. at room temperature and in air atmosphere. In another beaker, 8.7 mg of the Rhenium precursor NH₄ReO₄ were dissolved in 4 mL deionized water under fast stirring for 15 min. at room temperature and in air atmosphere.

The aqueous solution (8 mL) of the Pt precursor was added drop-wise to 10 g particles of SiO₂ under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was then dried for 2 hours in an oven at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of a Pt/Re catalyst on a SiO₂ support were obtained; total metal loading equal to 0.4% on the total weight of the supported catalyst; Re loading equal to 15% on the total weight of the metal loading corresponding to an atomic ratio Pt:Re=5.4:1.

### Example 15

### Synthesis of the Catalyst Based on Platinum and Rhenium on a SiO₂ Support: Pt_{75%} Re_{25%} on SiO₂

The following reagents were used to prepare the catalyst:
10 g SiO₂(BET=250 m²/g and porosity=1.0 cm³/g; granulometry=2-5 mm);
63.04 mg H₂PtCl₆;
14.5 mg NH₄ReO₄;
12 mL deionized water;
mixture of 5% H₂ in Ar (95%).

In a beaker, 63.04 mg of the Platinum precursor H₂PtCl₆ were dissolved in 8 mL deionized water under fast stirring for 15 min. at room temperature and in air atmosphere. In another beaker, 14.5 mg of the Rhenium precursor NH₄ReO₄ were dissolved in 4 mL deionized water under fast stirring for 15 min. at room temperature and in air atmosphere.

The aqueous solution (8 mL) of the Pt precursor was added drop-wise to 10 g particles of SiO₂ under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was then dried for 2 hours in an oven at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of a Pt/Re catalyst on a SiO₂ support were obtained; total metal loading equal to 0.4% on the total weight of the supported catalyst; Re loading equal to 25% on the total weight of the metal loading corresponding to an atomic ratio Pt:Re=2.8:1.

### Example 16

### Synthesis of the Catalyst Based on Platinum and Rhenium on a Carbon Support: Pt_{85%} Re_{15%} on C

The following reagents were used to prepare 10 gr catalyst:
10 g C (BET=590 m²/g and porosity=1.4 cm³/g; granulometry=3-6 mm);
71.45 mg H₂PtCl₆;
8.7 mg NH₄ReO₄;
12 mL deionized water;
mixture of 5% H₂ in Ar (95%).

In a beaker, 71.45 mg of the Platinum precursor H₂PtCl₆ were dissolved in 8 mL deionized water under fast stirring for 15 min. at room temperature and in air atmosphere. In another beaker, 8.7 mg of the Rhenium precursor NH₄ReO₄ were dissolved in 4 mL deionized water under fast stirring for 15 min. at room temperature and in air atmosphere.

The aqueous solution (8 mL) of the Pt precursor was added drop-wise to 10 g particles of carbon under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was then dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of a Pt/Re catalyst on a C support were obtained; total metal loading equal to 0.4% on the total weight of the supported catalyst; Re loading equal to 15% on the total weight of the metal loading corresponding to an atomic ratio Pt:Re=5.4:1.

### Example 17

### Synthesis of the Catalyst Based on Platinum and Rhenium on a Carbon Support: Pt_{75%} Re_{25%} on C

The following reagents were used to prepare 10 gr catalyst:
10 g C (BET=590 m²/g and porosity=1.4 cm³/g; granulometry=3-6 mm);
63.04 mg H₂PtCl6;
14.5 mg NH₄ReO₄;
12 mL deionized water;
mixture of 5% H₂ in Ar (95%).

In a beaker, 63.04 mg of the Platinum precursor H₂PtCl₆ were dissolved in 8 mL deionized water under fast stirring for 15 min. at room temperature and in air atmosphere. In another beaker, 14.5 mg of the Rhenium precursor NH₄ReO₄ were dissolved in 4 mL deionized water under fast stirring for 15 min. at room temperature and in air atmosphere.

The aqueous solution (8 mL) of the Pt precursor was added drop-wise to 10 g particles of carbon under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H2 and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was then dried for 2 hours in an oven at 100° C. in Ar atmosphere and then left to cool down slowly in Ar atmosphere. The dried sample was then subjected to reduction with H₂ diluted in Ar (5% H2 and 95% Ar) for 3 hours at 400° C. and left to cool down slowly in Ar atmosphere.

The sample obtained after reduction was subjected to mild oxidation with air at room temperature for 30 min. before exposure to the air.

10 g of a Pt/Re catalyst on a C support were obtained; total metal loading equal to 0.4% on the total weight of the supported catalyst; Re loading equal to 25% on the total weight of the metal loading corresponding to an atomic ratio Pt:Re=2.8:1.

### Example 18

### Synthesis of the Catalyst Based on Iridium and Rhenium on a TiO₂ Support: Ir_{85%} Re_{15%} on TiO₂

The following reagents were used to prepare 10 g catalyst:
10 g TiO₂ (BET=200 m²/g and porosity=1.0 cm³/g; granulometry=2-5 mm);
72 mg H₂IrCl₆;
8.7 mg NH₄ReO₄;
12 mL deionized water;
mixture of 5% H₂ in 95% Ar.

72 mg of the Iridium precursor H₂IrCl₆ were dissolved in 8 mL deionized water in a beaker under fast stirring for 15 minutes at room temperature and in open air. In another beaker, 8.7 mg of the Rhenium precursor NH₄ReO₄ were dissolved in 4 mL deionized water under fast stirring for 15 min., at room temperature and in air atmosphere.

The aqueous solution (8 mL) of the Ir precursor was added drop-wise to 10 g particles of TiO₂ under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was then dried for 2 hours in a stove at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Ir/Re catalyst on a TiO₂ support were obtained; total metal loading equal to 0.4% on the total weight of the supported catalyst; Re loading equal to 15% on the total weight of the metal loading corresponding to an atomic ratio Ir:Re=5.45:1.

### Example 19

### Synthesis of the Catalyst Based on Rhodium and Rhenium on a TiO₂ Support: Rh_{85%} Re_{15%} on TiO₂

The following reagents were used to prepare 10 gr catalyst:
10 g TiO₂ (BET=200 m²/g and porosity=1.0 cm³/g; granulometry=2-5 mm);
95 mg Rh(NO₃)₃;
8.7 mg NH₄ReO₄;
12 mL deionized water;
mixture of 5% H₂ in Ar (95%).

In a beaker, 95 mg of the Rhodium precursor Rh(NO₃)₃ were dissolved in 8 mL deionized water under fast stirring at room temperature and in air atmosphere. In another beaker, 8.7 mg of the Rhenium precursor NH₄ReO₄ were dissolved in 4 mL deionized water under fast stirring for 15 min., at room temperature and in air atmosphere.

The aqueous solution (8 mL) of the Rh precursor was added drop-wise to 10 g particles of TiO₂ under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample thus obtained was subjected to a second impregnation by drop-wise addition of the aqueous solution (4 mL) of the Re precursor. The sample was dried for 2 hours in a stove at 100° C. in Ar atmosphere and left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Rh/Re catalyst on a TiO₂ support were obtained; total metal loading equal to 0.4% on the total weight of the supported catalyst; Re loading equal to 15% on the total weight of the metal loading corresponding to an atomic ratio Ir:Re=10:1.

### Example A

### Synthesis of the Catalyst Based on Iridium on SiO₂/C/TiO₂ Supports

The following reagents were used to prepare 10 gr catalyst:
10 g support (SiO₂ or C or TiO₂);
84 mg H₂IrCl₆;
10 mL deionized water;
mixture of 5% H₂ in 95% Ar.

In a beaker, 84 mg of the Iridium precursor H₂IrCl₆ were dissolved in 10 mL deionized water under fast stirring for 15 min. in open air and at room temperature. The aqueous solution (10 mL) of the Ir precursor was added drop-wise to 10 g particles of support under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Ir catalyst on a support were obtained; total metal loading equal to 0.4% on the total weight of the supported catalyst.

### Example B

### Synthesis of the Catalyst Based on Rhodium on SiO₂/C/TiO₂ Supports

The following reagents were used to prepare 10 gr catalyst:
10 g support (SiO₂ or C or TiO₂);
112 mg Rh(NO₃)₃;
10 mL deionized water;
mixture of 5% H₂ in 95% Ar.

In a beaker, 112 mg of the Rhodium precursor Rh(NO₃)₃ were dissolved in 10 mL deionized water under fast stirring for 15 min. in open air and at room temperature. The aqueous solution (10 mL) of the Rh precursor was added drop-wise to 10 g particles of support under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Rh catalyst on a support were obtained; total metal loading equal to 0.4% on the total weight of the supported catalyst.

### Example C

### Synthesis of the Catalyst Based on Platinum on SiO₂C Supports

The following reagents were used to prepare 10 gr catalyst:
10 g support (SiO₂ or C);
84 mg H₂PtCl₆;
10 mL deionized water;
mixture of 5% H₂ in 95% Ar.

In a beaker, 84 mg of the Platinum precursor H₂PtCl₆ were dissolved in 10 mL deionized water under fast stirring for 15 min. in open air and at room temperature. The aqueous solution (10 mL) of the Pt precursor was added drop-wise to 10 g particles of support under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Pt catalyst on a support were obtained; total metal loading equal to 0.4% on the total weight of the supported catalyst.

### Example D

### Synthesis of the Catalyst Based on Rhenium on SiO₂/C/TiO₂ Supports

The following reagents were used to prepare 10 gr catalyst:
10 g support (SiO₂ or C or TiO₂);
58 mg NH₄ReO₄;
10 mL deionized water;
mixture of 5% H₂ in 95% Ar.

In a beaker, 58 mg of the Rhenium precursor NH₄ReO₄ were dissolved in 10 mL deionized water under fast stirring for 15 min. in open air and at room temperature. The aqueous solution (10 mL) of the Re precursor was added drop-wise to 10 g particles of support under stirring in a 100 mL beaker. The resulting sample was dried for 2 hours in an oven at 100° C. in Ar atmosphere and then left to cool down slowly in Ar atmosphere. The dried sample was then subjected to reduction with H₂ diluted in Ar (5% H₂ and 95% Ar) for 3 hours at 400° C. and left to cool down slowly in Ar atmosphere.

The sample obtained after reduction was subjected to mild oxidation with air at room temperature for 30 min. before exposure to the air.

10 g of an Re catalyst on a support were obtained; total metal loading equal to 0.4% on the total weight of the supported catalyst.

The catalysts so prepared were tested in the reduction of chlorate ClO₃⁻ and perchlorate ClO₄⁻ ions, as described in the following examples.

### Example 20

### Reduction of Chlorate ClO₃⁻ and Perchlorate ClO₄⁻ Ions Catalysed with Catalyst Based on Ir/Re on SiO₂: Ir_{95%} Re_{5%} on SiO₂ (Example 1), Ir_{85%} Re_{15%} on SiO₂ (Example 3) and Ir_{75%} Re_{25%} on SiO₂ (Example 4)

The reduction reaction of chlorate was carried out in a IL reactor and the reaction mixture consisted of 1000 ppm NaClO₃, 180 g/L NaCl, 8 g/L Na₂SO₄ in 500 mL brine. The reduction was performed with a flow of H₂ of 30 mL/minute at temperature of 70° C. and pH equal to 2 in presence of 1 g catalyst in the form of pellets.

The reduction reaction of perchlorate was carried out under similar conditions; in this case, the substrate for the reaction consisted of 1000 ppm NaClO₄.

The catalytic activity of the Ir/Re catalysts was compared with the catalytic activity of the monometallic catalysts based on Ir or Re having a total metal loading equal to 0.4% on the total weight of the supported catalyst as prepared in example A and D respectively.

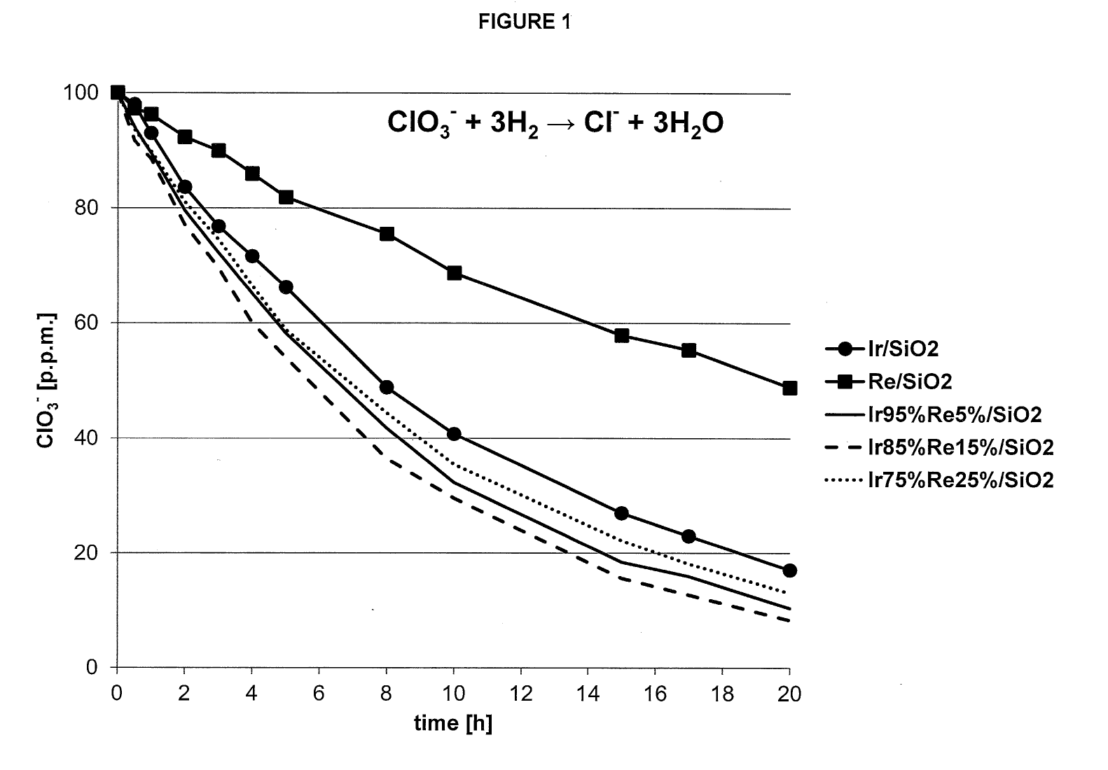

The results obtained are shown in FIG. 1 (reduction of the ClO₃⁻ ions) and 2 (reduction of ClO₄⁻ ions).

### Example 21

### Reduction of Chlorate ClO₃⁻ and Perchlorate ClO₄⁻ Ions Catalysed with Catalyst Based on Ir/Re on C: Ir_{95%} Re_{5%} on C (Example 5), Ir_{85%} Re_{15%} on C (Example 6) and Ir_{75%} Re_{25%} on C (Example 7)

The conditions for the reduction of chlorate and perchlorate anions are as described in example 20.

The results obtained are shown in FIG. 3 (reduction of the ClO₃⁻ ions) and 4 (reduction of ClO₄⁻ ions).

### Example 22

### Reduction of Chlorate ClO₃⁻ and Perchlorate ClO₄⁻ Ions, Catalysed with Catalyst Based on Rh/Re on SiO₂: Rh_{95%} Re_{5%} on SiO₂ (Example 8), Rh_{85%} Re_{15%} on SiO₂ (Example 9) and Rh_{75%} Re_{25%} on SiO₂ (Example 10)

The conditions for the reduction of chlorate and perchlorate anions are as described in example 20.

The catalytic activity of the Rh/Re catalysts was compared with the catalytic activity of the monometallic catalysts based on Rh or Re having total metal loading equal to 0.4% on the total weight of the supported catalyst as prepared in example B and D respectively.

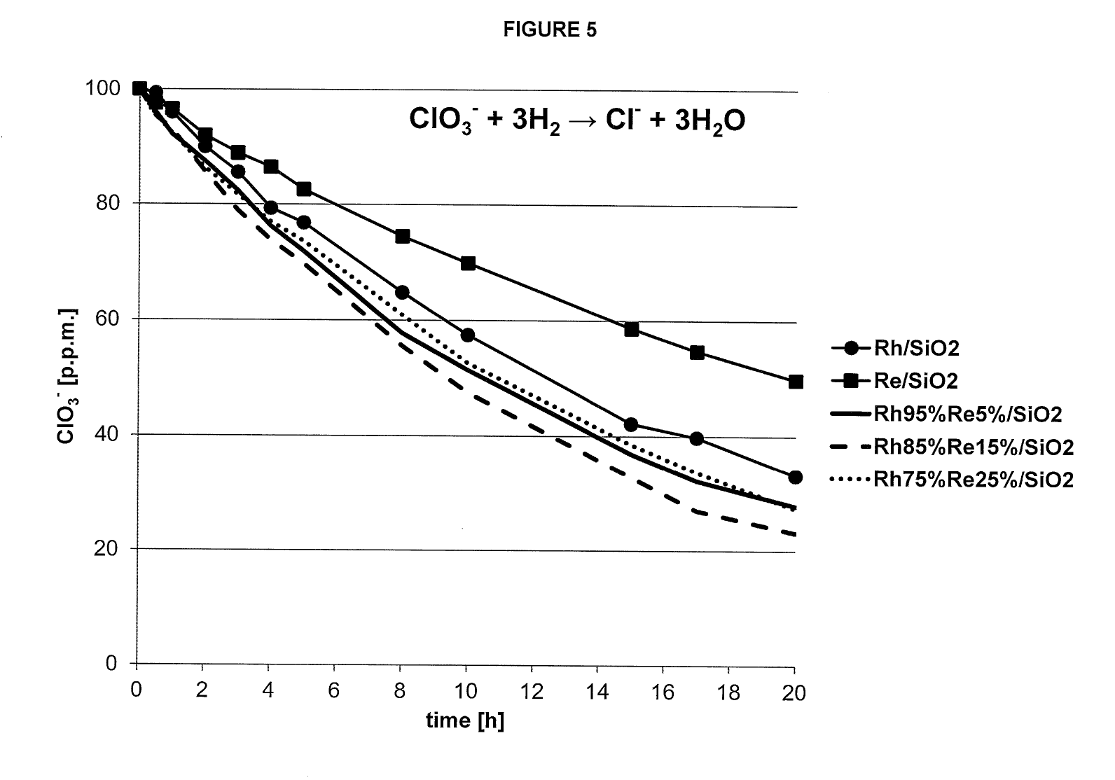

The results obtained are shown in FIG. 5 (reduction of the ClO₃⁻ ions) and 6 (reduction of ClO₄⁻ ions).

### Example 23

### Reduction of Chlorate ClO₃⁻ and Perchlorate ClO₄⁻ Ions, Catalysed with Catalyst Based on Rh/Re on C: Rh_{95%} Re_{5%} on C (Example 11), Rh_{85%} Re_{15%} on C (Example 12) and Rh_{75%} Re_{25%} on C (Example 13)

The conditions for the reduction of chlorate and perchlorate anions are as described in examples 20 and 22.

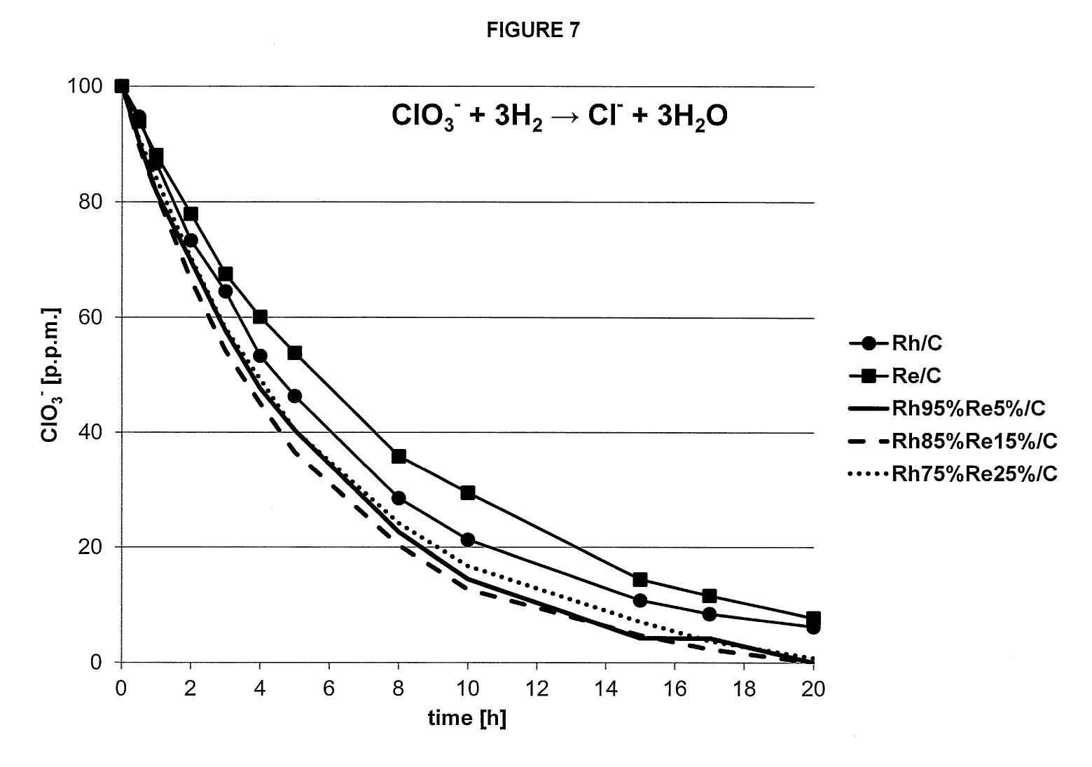

The results obtained are shown in FIG. 7 (reduction of the ClO₃⁻ ions) and 8 (reduction of ClO₄⁻ ions).

### Example 24

### Reduction of Chlorate ClO₃⁻ and Perchlorate ClO₄⁻ Ions Catalysed with Catalyst Based on Pt/Re on Pt_{85%} Re_{15%} on SiO₂ (Example 14), Pt_{75%} Re_{25%} on SiO₂ (Example 15)

The conditions for the reduction of chlorate and perchlorate anions are as described in example 20.

The catalytic activity of the Pt/Re catalysts was compared with the catalytic activity of the monometallic catalysts based on Pt or Re having a total metal loading equal to 0.4% on the total weight of the supported catalyst as prepared in example C and D respectively.

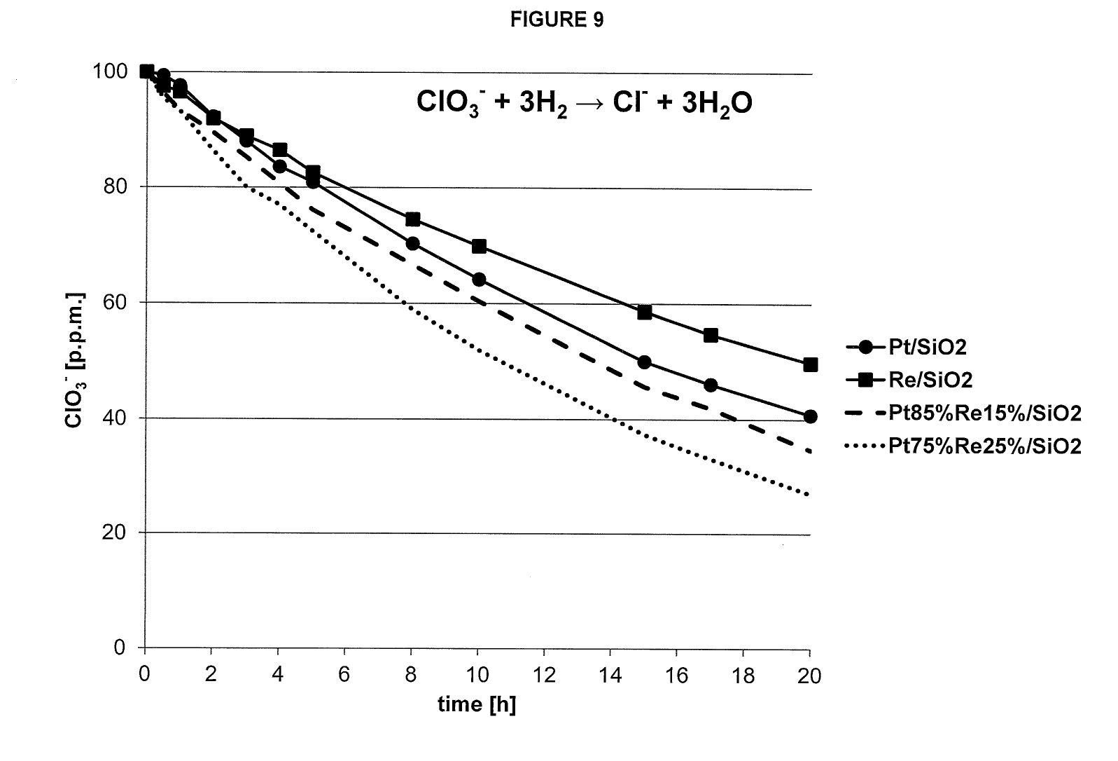

The results obtained are shown in FIG. 9 (reduction of the ClO₃⁻ ions) and 10 (reduction of ClO₄⁻ ions).

### Example 25

### Reduction of Chlorate ClO₃⁻ and Perchlorate ClO₄⁻ Ions, Catalysed with Catalyst Based on Pt/Re on C: Pt_{85%} Re_{15%} on C (Example 16), Pt_{75%} Re_{25%} on C (Example 17)

The conditions for the reduction of chlorate and perchlorate anions are as described in examples 20 and 24.

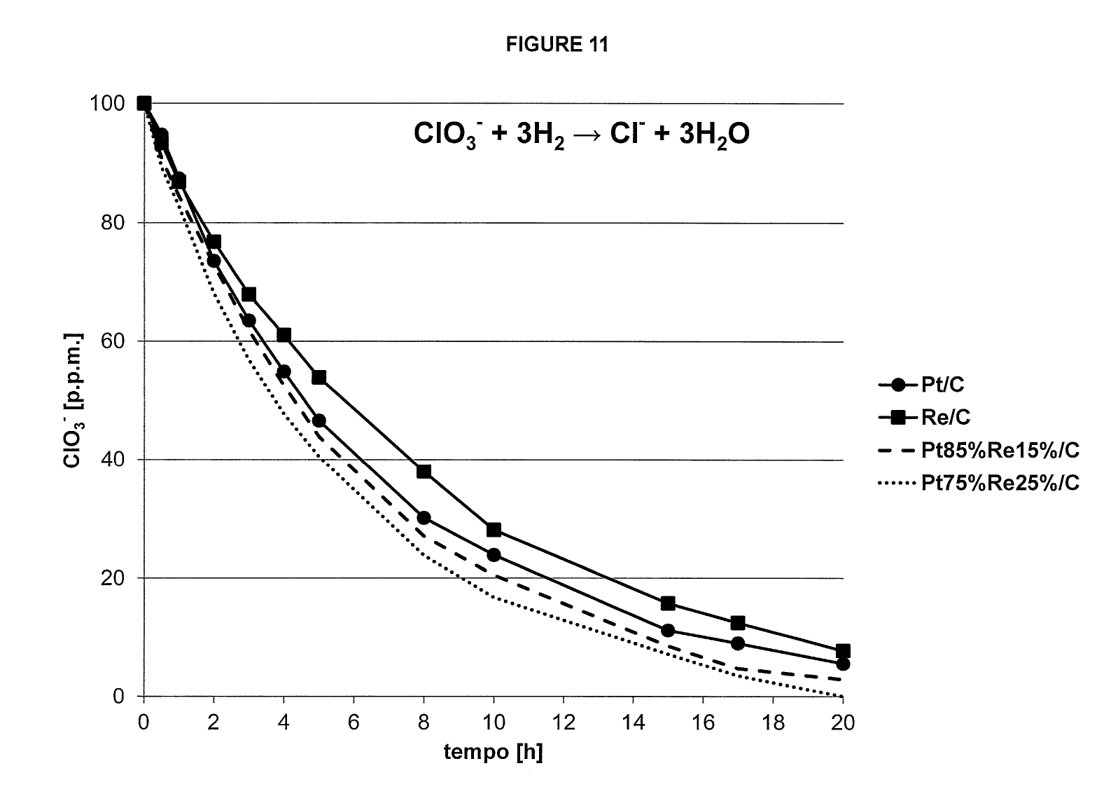

The results obtained are shown in FIG. 11 (reduction of the ClO₃⁻ ions) and 12 (reduction of ClO₄⁻ ions).

### Example 26

### Reduction of Chlorate ClO₃⁻ and Perchlorate ClO₄⁻ Ions, Catalysed with Catalyst Based on Ir/Re on TiO₂: Ir_{85%} Re_{15%} on TiO₂ (Example 18)

The conditions for the reduction of chlorate and perchlorate anions are as described in example 20.

The catalytic activity of the Ir/Re catalyst was compared with the catalytic activity of the monometallic catalysts based on Ir or Re having a total metal loading equal to 0.4% on the total weight of the supported catalyst as prepared in example A and D respectively.

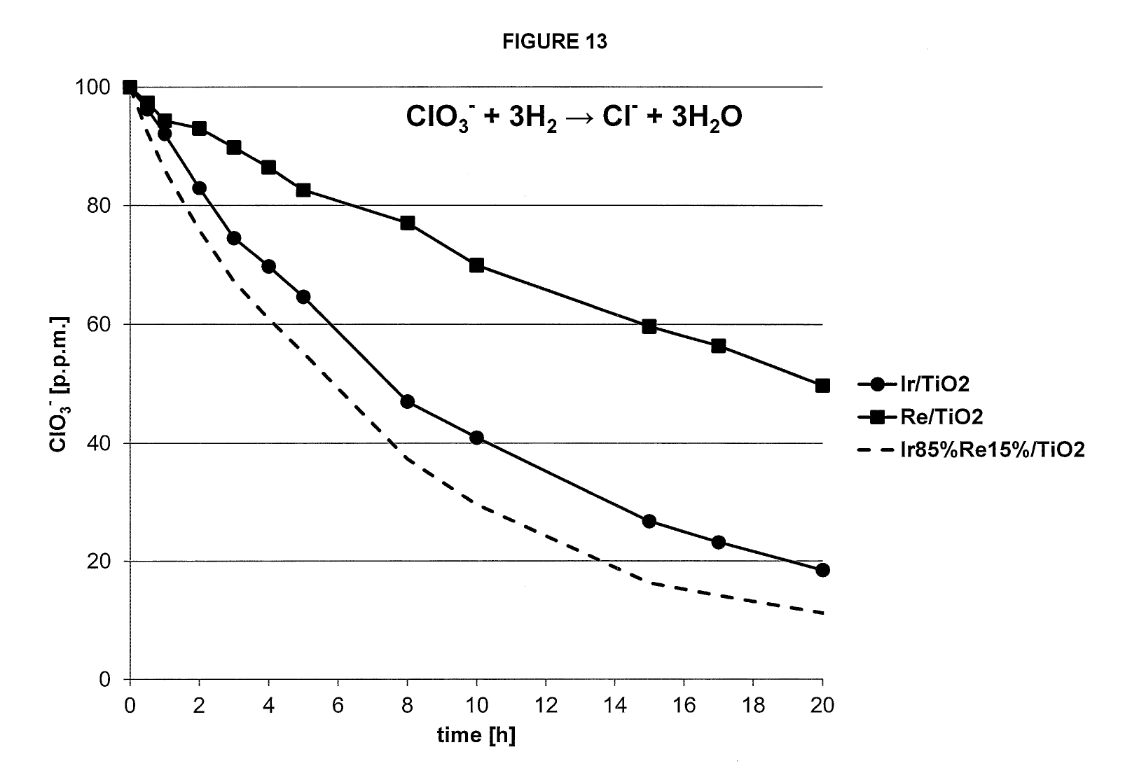

The results obtained are shown in FIG. 13 (reduction of the ClO₃⁻ ions) and 14 (reduction of ClO₄⁻ ions).

### Example 27

### Reduction of Chlorate ClO₃⁻ and Perchlorate ClO₄⁻ Ions, Catalysed with Catalyst Based on Rh/Re on TiO₂: Rh_{85%} Re_{15%} on TiO₂ (Example 19)

The catalytic activity of the Rh/Re catalyst was compared with the catalytic activity of the monometallic catalysts based on Rh or Re having a total metal loading equal to 0.4% on the total weight of the supported catalyst as prepared in example B and D respectively.

The conditions for the reduction of chlorate and perchlorate anions are as described in example 20.

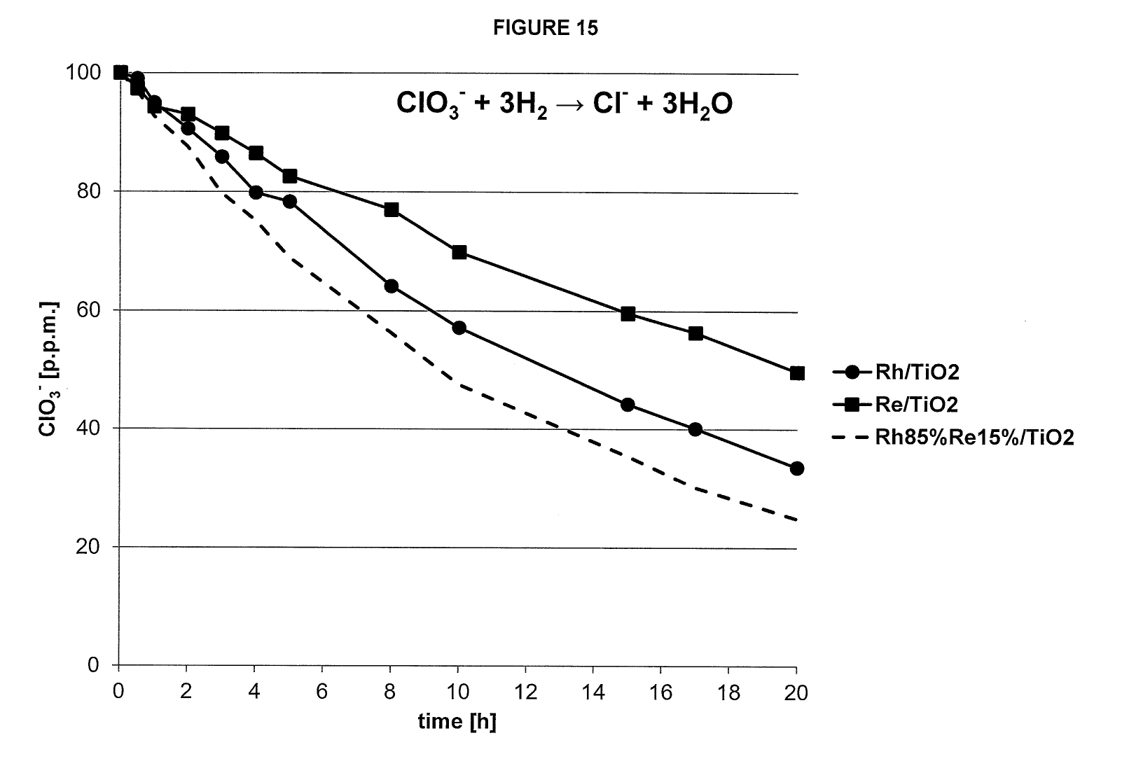

The results obtained are shown in FIG. 15 (reduction of the ClO₃⁻ ions) and 16 (reduction of ClO₄⁻ ions).

1. A method for removing halogen oxyanions from aqueous solutions by hydrogenation reduction, characterized in that the hydrogenation reduction reaction is catalysed by a supported bimetallic catalyst comprising rhenium in combination with a noble metal of subgroup VIII of the Periodic Table of the Elements.

2. The method according to claim 1, wherein the noble metal of subgroup VIII of the Periodic Table of the Elements is selected from iridium, rhodium and platinum.

3. The method according to claim 2, wherein the noble metal of subgroup VIII of the Periodic Table of the Elements is iridium.

4. The method according to claim 1, wherein the total content of metal is between 0.1 and 10% by weight on the total weight of the catalyst.

5. The method according to claim 4, wherein the total content of metal is between 0.1 and 1% by weight on the total weight of the catalyst.

6. The method according to claim 1, wherein the loading of rhenium is from 1 to 50% by weight of the total metal loading.

7. The method according to claim 6, wherein the loading of rhenium is at least 5% by weight of the total metal loading.

8. The method according to claim 6, wherein the loading of rhenium in combination with iridium or rhodium is from 5 to 25% by weight of the total metal loading.

9. The method according to claim 6, wherein the loading of rhenium in combination with platinum is from 15 to 35% by weight of the total metal loading.

10. The method according to one of claim 1, wherein the support material is selected from silicon, aluminium, magnesium, titanium, cerium, zirconium and yttrium oxides and mixtures thereof.

11. The method according to claim 10, wherein the support material is SiO₂.

12. The method according to one of claim 1, wherein the support material is selected from carbon, and carbon and silicon mixtures.

13. The method according to claim 12, wherein the support material is carbon.

14. The method according to claim 1, wherein the hydrogenation reduction comprises at least the step of treating the aqueous solutions with a hydrogen flow in presence of a supported bimetallic catalysts comprising rhenium in combination with noble metals of subgroup VIII of the Periodic Table of the Elements as defined in one of the claims from 2 to 13.

15. The method according to claim 1, wherein the hydrogenation reduction is carried out at temperatures comprised from 50° C. to 90° C. and pH from 2.0 to 3.0.

16. A supported bimetallic catalyst comprising rhenium in combination with a noble metal of subgroup VIII of the Periodic Table of the Elements for use in the hydrogenation reduction of halogen oxyanions.

17. The supported bimetallic catalyst according to claim 16, wherein the noble metal of subgroup VIII of the Periodic Table of the Elements is selected from iridium, rhodium and platinum.

18. The supported bimetallic catalyst according to claim 16, wherein the total metal content is between 0.1 and 10% by weight on the total weight of the catalyst.

19. The supported bimetallic catalyst according to claim 18, wherein the total metal content is between 0.1 and 1% by weight on the total weight of the catalyst.

20. The supported bimetallic catalyst according to claim 16, wherein the loading of rhenium is from 1 to 50% by weight of the total metal loading.

21. The supported bimetallic catalyst according to claim 20, wherein the loading of rhenium is at least 5% by weight of the total metal loading.

22. The supported bimetallic catalyst according to claim 20, wherein the loading of rhenium in combination with iridium or rhodium is from 5 to 25% by weight of the total metal loading.

23. The supported bimetallic catalyst according to claim 20, wherein the loading of rhenium in combination with platinum is from 15 to 35% by weight of the total metal loading.

24. The supported bimetallic catalyst according to claim 16, wherein the support material is selected from silicon, aluminum, magnesium, titanium, cerium, zirconium and yttrium oxides and mixtures thereof.

25. The supported bimetallic catalyst according to claim 24, wherein the support material is SiO₂.

26. The supported bimetallic catalyst according to claim 16, wherein the support material is selected from carbon, and carbon and silicon mixtures.

27. The supported bimetallic catalyst according to claim 26, wherein the support material is carbon.
